(19) United States
(12) Patent Application Publication
(10) Pub. No.: US 2008/0001743 A1
(43) Pub. Date: Jan. 3, 2008

(54) Flashlight With Attached Audible Alarm

(76) Inventor: David Gallagher, McKees Rocks, PA (US)

Correspondence Address: THE WEBB LAW FIRM, P.C., 700 KOPPERS BUILDING, 436 SEVENTH AVENUE, PITTSBURGH, PA, 15219, US

(21) Appl. No.: 11/769,211

(22) Filed: Jun. 27, 2007

Related U.S. Application Data
(60) Provisional application No. 60/817,457, filed on Jun. 29, 2006.

(51) Int. Cl. G08B 13/14

(52) U.S. Cl. 340/571

(57) ABSTRACT

A portable alarm device is made up of a flashlight having a body. An audible alarm is attached to the flashlight body and the flashlight body is removably supported by a station. The station is adapted to be secured to a surface having an orientation that may range from horizontal to vertical. A switch between the flashlight body and the station is activated when the flashlight body is removed from the station, thereby activating the audible alarm.

### CROSS REFERENCE TO RELATED APPLICATIONS

This application claims the benefit of U.S. Provisional Application No. 60/817,457 filed Jun. 29, 2006.

### BACKGROUND OF THE INVENTION

1. Field of the Invention

The invention relates to personal security devices and, more specifically, to a flashlight having attached thereto a personal alarm to locate the holder of the flashlight when not clearly visible.

2. Description of Related Art

In an emergency such as, but not limited to, a fire, a child tends to hide in a familiar place such as a closet. Many times, rescuers on the scene of an emergency are unable to locate and save such individuals. As an example, a child in a burning building hiding in a closet may not be discovered by rescuers even if the rescuers are in the same room. Since most deaths from fires are caused by asphyxiation from smoke inhalation, speedy rescues are critical to saving lives and, by such actions, children greatly reduce their chances for rescue. In another situation, an adult may unexpectedly become incapacitated in an area where the adult would not be easily seen and, therefore, rescue may be delayed.

Rescuers are trained to listen and look for unusual sounds or sights that would indicate the presence of a person. While it would be extremely helpful to rescuers, it is unlikely without other benefits that a child or an adult would carry an audible or visual alarm to be activated in time of need. U.S. Pat. No. 6,040,780 to Lucas discloses a child's personal security assistant intended for use during house fires to assist rescuers in finding trapped or hidden children. A base 2 rests upon a horizontal surface, such as a night stand, and when the body 4 is removed from the base 2, an audible alarm and strobe light on the body 4 are activated. The body 4 also functions as a flashlight 12.

U.S. Pat. No. 7,033,042 to Lim discloses an emergency flashlight including a body 210 and a holder 220. The holder 220 may be affixed to a wall. When the body 210 is removed from the holder 220, the flashlight turns on and an audible alarm, within the flashlight body, is activated.

A device is needed that would induce a person to carry such an audible and/or visual alarm in times of need and that would be secured to a particular location.

### SUMMARY OF THE INVENTION

The invention is directed to a portable alarm device comprised of a flashlight having a body and an audible alarm attached to the flashlight body. The alarm has a station for removably supporting the flashlight body, wherein the station is adapted to be secured to a surface and wherein the orientation of the surface may range from horizontal to vertical. The alarm has an electrical circuit comprised of a portable power source, an audible alarm and a switch to connect the power source and the audible alarm. The switch is closed to activate the audible alarm by removing the flashlight body from the station. There may also be associated with the flashlight body, a visual alarm such as a flashing light that would be activated simultaneously with the audible alarm. With such a device, a person in need of a flashlight would simultaneously be provided with an audible and/or visual alarm that could be used by a rescuer to locate the person.

A method for revealing the location of an individual desiring to use the light from a flashlight comprises the steps of providing a flashlight with a body having an audible alarm, releasably securing the flashlight body in a holder, and providing a switch sensitive to the position of the flashlight body within the holder. In a first position with the flashlight body secured within the holder, the switch is open and the audible alarm is disabled. In a second position with the flashlight body removed from the holder by the individual, the switch is closed and the audible alarm is enabled, thereby identifying the location of the individual by the audio signal emitted from the flashlight.

### BRIEF DESCRIPTION OF THE SEVERAL VIEWS OF THE DRAWINGS

FIG. 1 illustrates a perspective view of the flashlight mounted within the station;

FIGS. 2-4 illustrate the progression of steps whereby the flashlight is removed from a station;

FIG. 5 is a side perspective view of the station;

FIG. 6 is a front perspective view of the station;

FIG. 7 is a bottom view of the station;

FIG. 8 illustrates the flashlight with its various components;

FIG. 9 is an elevation view of a second embodiment of the device using an audio jack for power; and

FIG. 10 is a schematic electrical diagram of the alarm circuit.

### DETAILED DESCRIPTION OF THE INVENTION

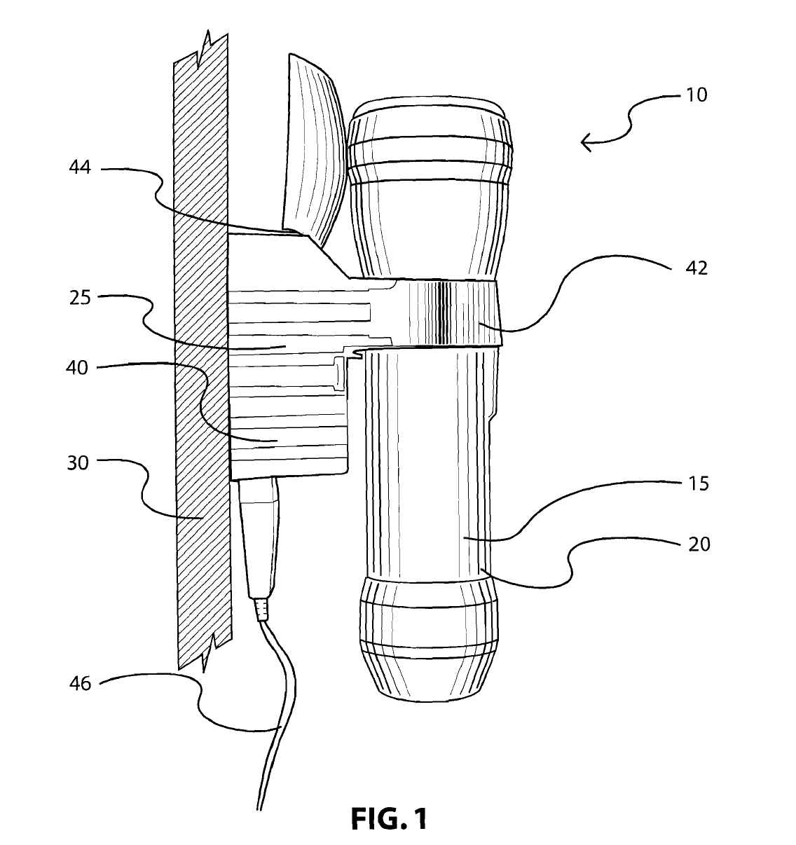

FIG. 1 illustrates the portable alarm device 10 in accordance with the subject invention. A flashlight 15 having a flashlight body 20 is removably supported by a station 25. The station 25 is adapted to be secured to a surface 30, such as a wall. The orientation of the surface 30 may range from horizontal to vertical. However, it is significant that the station 25 is secured to the surface 30 as opposed to resting upon the surface.

The station 25 may be secured to the surface 30 utilizing fasteners or adhesives (not shown).

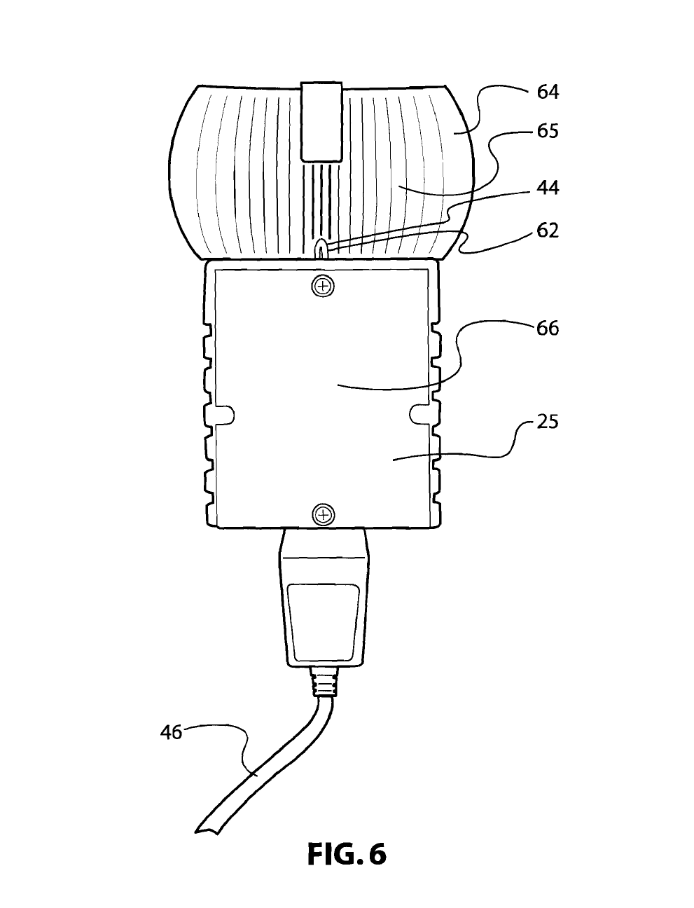

The station 25 may be comprised of a base 40 having two resilient prongs 42 extending therefrom, which secure the body 20 of the flashlight 15 therein. The base 40 may further include a locator light 44 (also FIG. 6) intended to remain illuminated so that the flashlight 15 may be located even in the darkness or in a dusty or smoke-filled environment. The locator light 44 may be powered by alternating current supplied through a power cord 46.

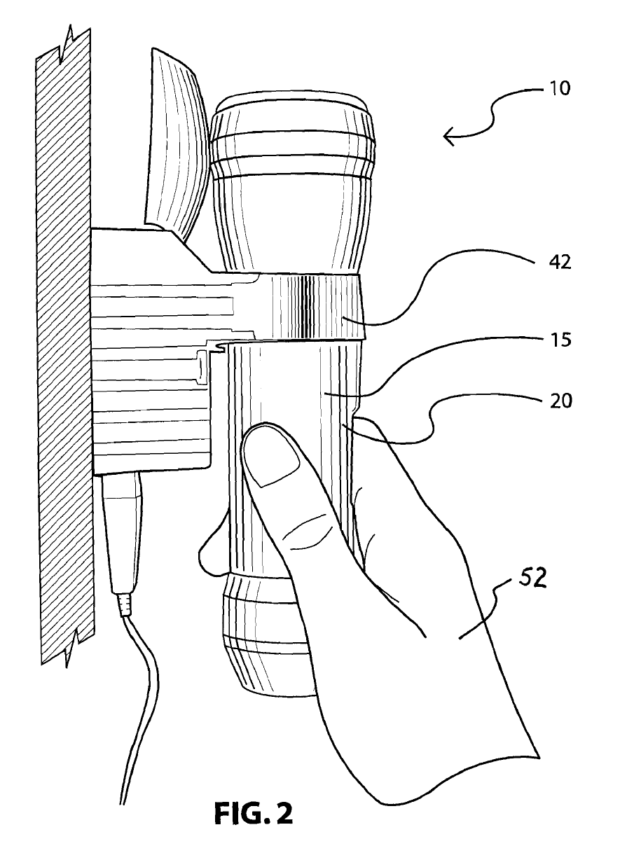

FIGS. 2-4 illustrate the procedure for activating the portable alarm device 10. In particular, directing attention to FIG. 2, the flashlight body 20 may be grasped by a hand 52 and pulled away from the resilient prongs 42.

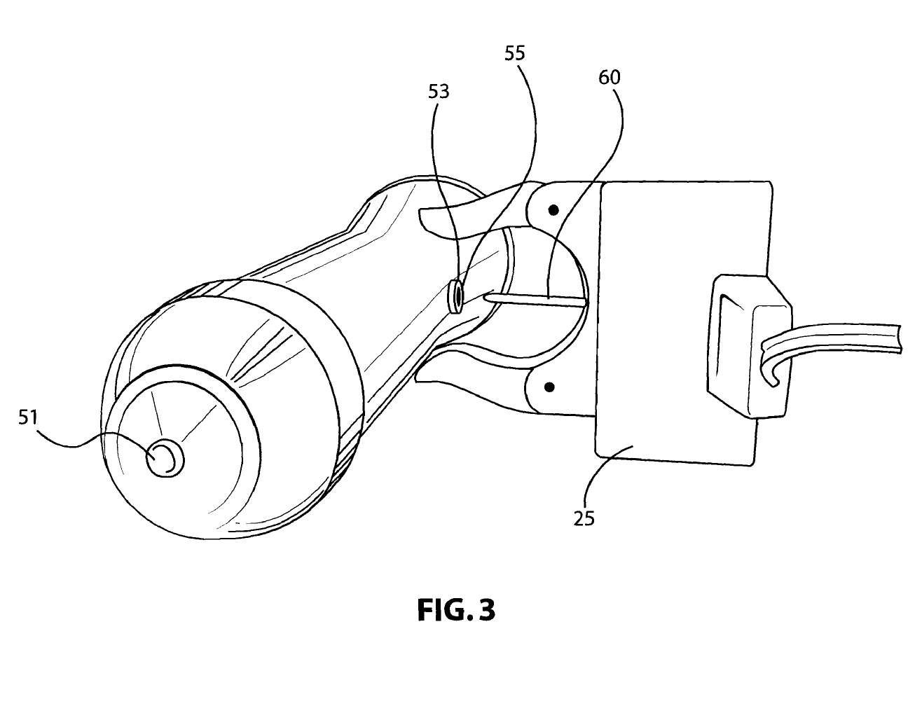

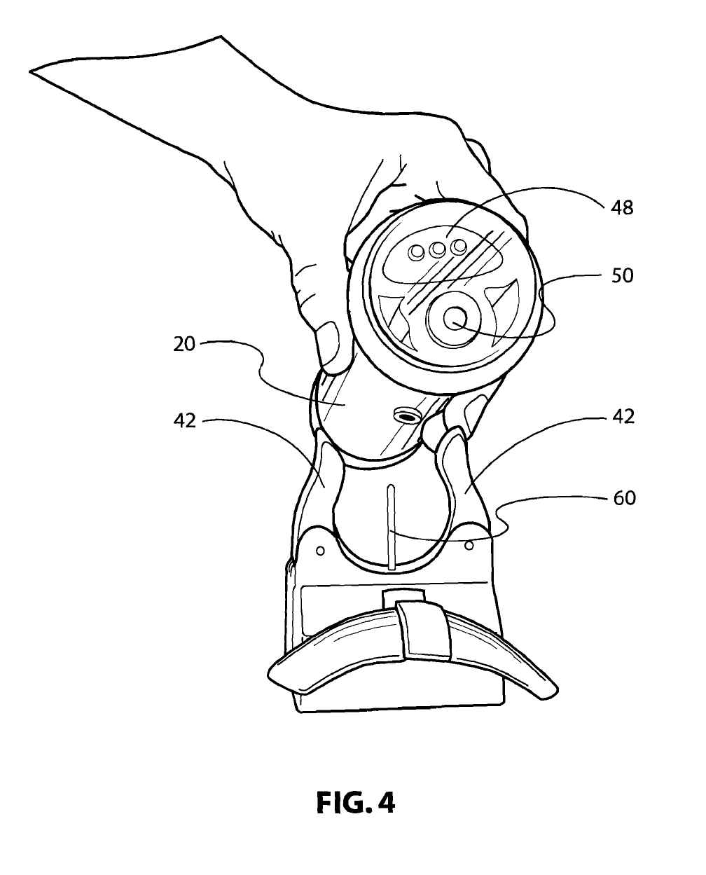

Directing attention to FIG. 3, there is a switch 55 mounted within the body 20 and the switch is activated by removing the flashlight body 20 from the station 25. In particular, in the embodiment illustrated in FIG. 3, the switch 55 is a mechanical circuit which is biased in the closed position such that the alarm is activated. A deactivation post 60 extends from the station 25 and is aligned with the switch 55 in the body 20 of the flashlight 15. When the deactivation post 60 is inserted within the switch 55, as illustrated in FIG. 2, the alarm, which may be an audible alarm 50 (FIG. 2) with or without a visual alarm, such as a beacon 51 (FIG. 3), is deactivated. The beacon 51 may illuminate or flash at the same time the audible alarm 50 is activated. In the alternative or additionally, the beacon 51 may be substituted with or supplemented with a strobe light that would be more visible to others. The beacon 50 is separate from an illumination element 48 (FIG. 4) of the flashlight 15.

However, upon removing the flashlight body 20 from the station 25, the deactivation post 60 is removed from a cavity 53 and contact with the switch 55, thereby biasing the switch 55 to the closed position, activating the audible alarm 50 and/or the visual alarm, as illustrated in FIG. 4. In one embodiment, the illumination element 48 of the flashlight body 20 and the beacon 51 are both activated by the switch 55. However, it is entirely possible for the illumination element 48 to be manually activated by the user. In this manner, the user may be able to conserve power for use by the alarms.

Hereinafter, reference will be made to activation of the audible alarm 50 with the understanding that there may also be a visual alarm present, and this visual alarm may be simultaneously activated by the switch 55.

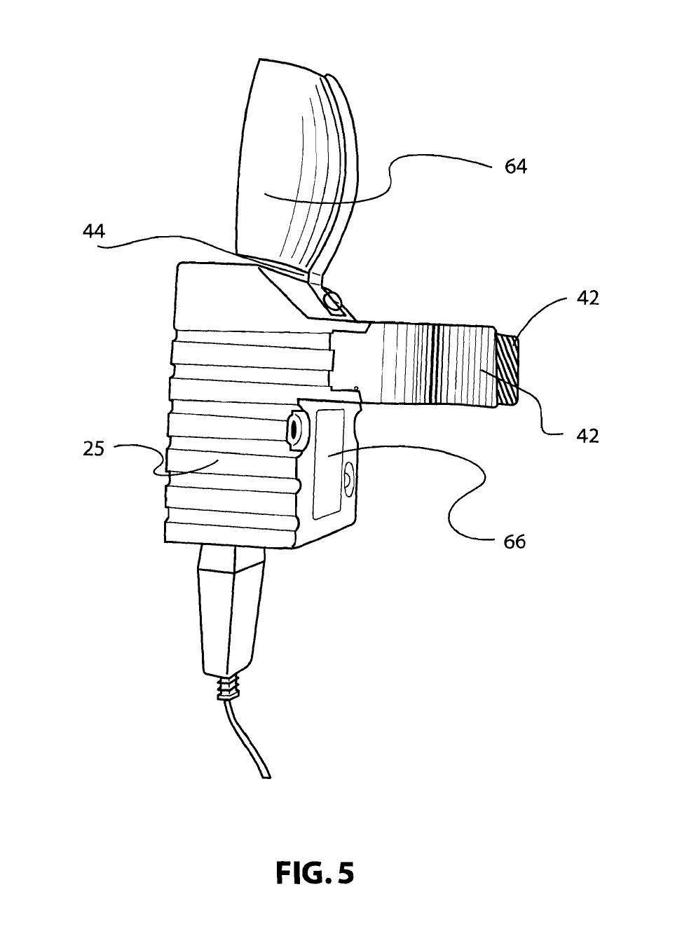

Details of the station 25 are illustrated in FIGS. 5-7. As previously stated, the base 40 of the station 25 includes two opposing resilient prongs 42 adapted for removably supporting the flashlight body 20 (FIG. 1). The base 40 of the station 25 may also include a locator light 44 which is illustrated in FIG. 6 as comprised of a small LED 62 which, in the embodiment illustrated herein, is powered through alternating current provided through a power cord 46 into an AC outlet (not shown). A reflector face 65 maximizes the effect of the LED 62. However, it should be appreciated that the device may be utilized without such a reflector. The station 25 may house a small adapter 66 to step down the household current to a level acceptable for the LED 62.

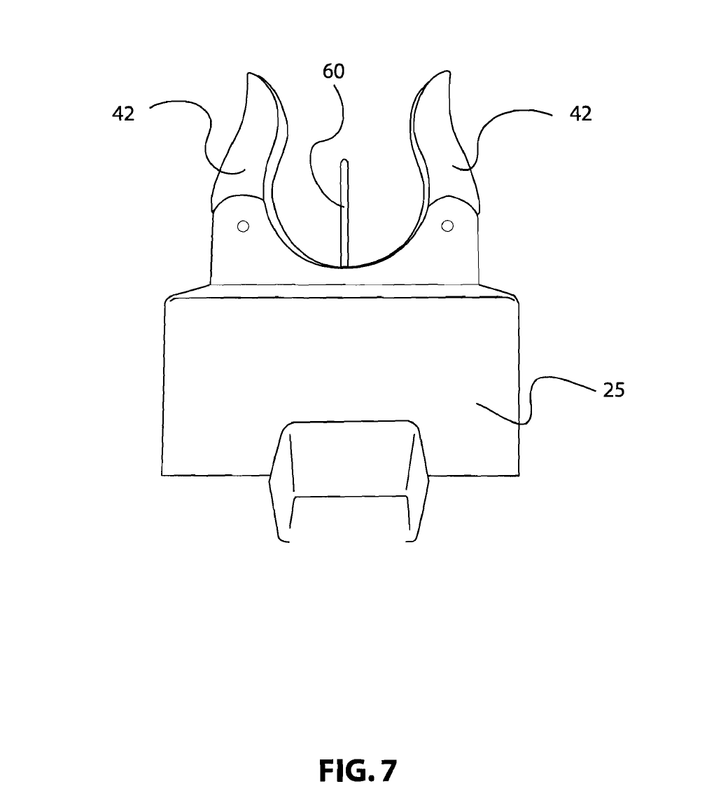

FIG. 7 clearly illustrates the resilient prongs 42 and the deactivation post 60 mounted on the station 25.

What has so far been discussed is a portable alarm device 10 having an LED 62 attached to a station 25, which itself is secured to a surface 30.

The audible alarm 50, the illumination element 48, and/or the beacon 51 are powered by a stand-alone power supply, such as a long-life battery, which may be a 9-volt long-life battery.

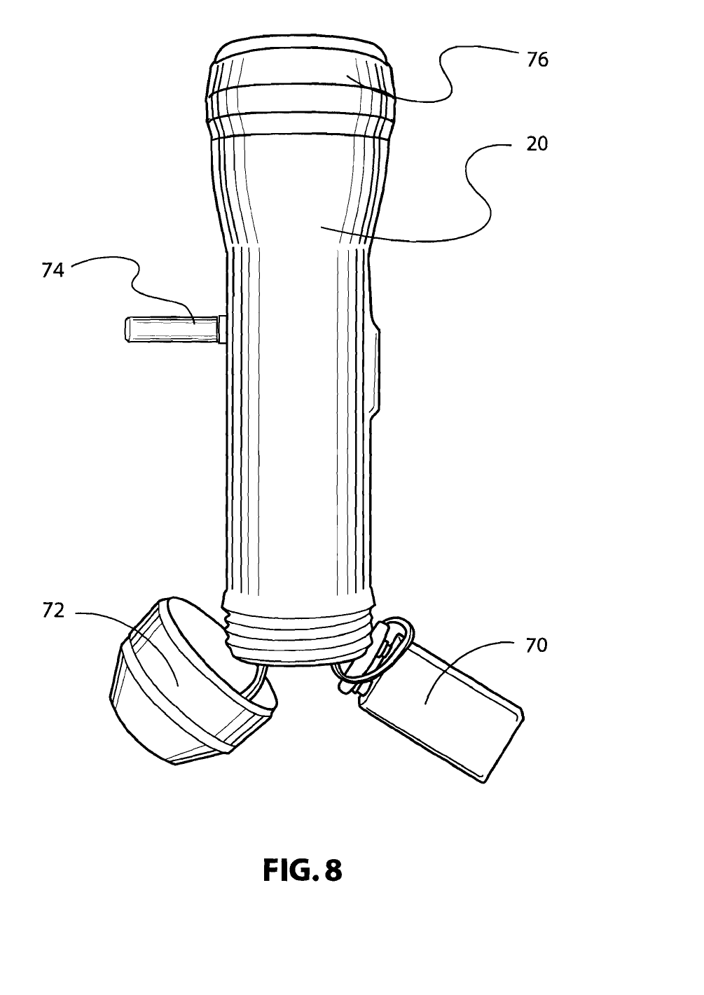

FIG. 8 provides a view of the flashlight body 20 partially disassembled such that an independent power supply 70 is visible. In particular, the power supply 70 is a 9-volt battery secured within the flashlight body 20 using an end cap 72. It should be appreciated that a deactivation element 74 illustrated in FIG. 8 provides the same function as the deactivation post 60 and permits the audible alarm 50 to be deactivated outside of the station 25 for maintaining/testing purposes

Just as with maintenance of a smoke alarm, the portable alarm device 10 may be tested at regular intervals and, at such time, the battery replaced. It is also possible to provide in lieu of such a battery, a rechargeable battery that may be recharged through the station at the time the flashlight body 20 is secured within the station 25.

It is entirely possible for the LED 62, which is the locator light 44, to be mounted directly upon the flashlight body 20 independently of the station 25, as opposed to mounting the locator light 44 on the station 25. The locator light 44 so far has been discussed as an LED. However, in lieu of an LED, any low-power source of illumination will be sufficient.

The switch 55 between the flashlight body 20 and the station 25, as discussed so far, requires a deactivation post 60. It is entirely possible for another type of switch to be utilized such as a reed switch or another proximity switch that utilizes no physical connections. However, it is important that once the flashlight body 20 is removed from the station 25, the audible alarm 50 may not be easily deactivated, since this would defeat the purpose of the invention.

Briefly returning, FIG. 3 illustrates a perspective view of the flashlight body 20 with a view of the switch 55 into which the deactivation post 60 is inserted. What has been so far described is a self-contained battery-operated emergency flashlight and audible alarm system supplied with what may be a 110-volt nightlight. Additionally, the flashlight body 20 may be made of molded plastic and can be of a fluorescent color. The shape and design of the flashlight body 20 must be consistent with the space necessary to house the circuitry, audible alarm, and the beacon 51. The beacon 51 may be a flashing red illuminating element which may be more easily visible through a dusty or smoky environment. Just as the end cap 72 may be removed for access to the power supply 70, a top cap 76 (FIG. 8) may also be removed in the event the audible alarm 50 or the illumination element 48 must be replaced. As a general guideline, the audible alarm should conform to the same sound standards as a smoke alarm. Furthermore, the audible alarm 50 should have a distinctly different sound than that of a smoke alarm so that a rescuer does not confuse the sound of a smoke alarm with that of the portable alarm device 10.

The subject invention forces an individual wishing to utilize the flashlight to carry with them the activated audible alarm and/or a beacon which permits rescuers to locate them. The audible alarm 50, in accordance with the subject invention, may be a self-contained two-toned fast pulse piezoelectric transducer, although other devices such as speakers with separate tone generation circuitry could be substituted. The benefit of the present audible alarm is the distinctive output tone and volume as well as the low current draw.

The illumination element 48 currently comprises the array of three LEDs with a reflector. This combination was chosen on the basis of reliability, as well as light output vs. current draw in order to optimize battery life when in use. The LED array requires 4.5 volts which was obtained via a voltage divider utilizing resisters. Other devices could be employed to produce the necessary voltage, including voltage regulators, as well as other electronic circuits capable of providing the necessary voltage. Other combinations could be substituted, including incandescent lamps.

The flashing LED functions as an adjunct visual location device and is comprised of a discrete flashing LED chosen for its visual output characteristics as well as its low current draw. Other combinations of output devices could be employed as well.

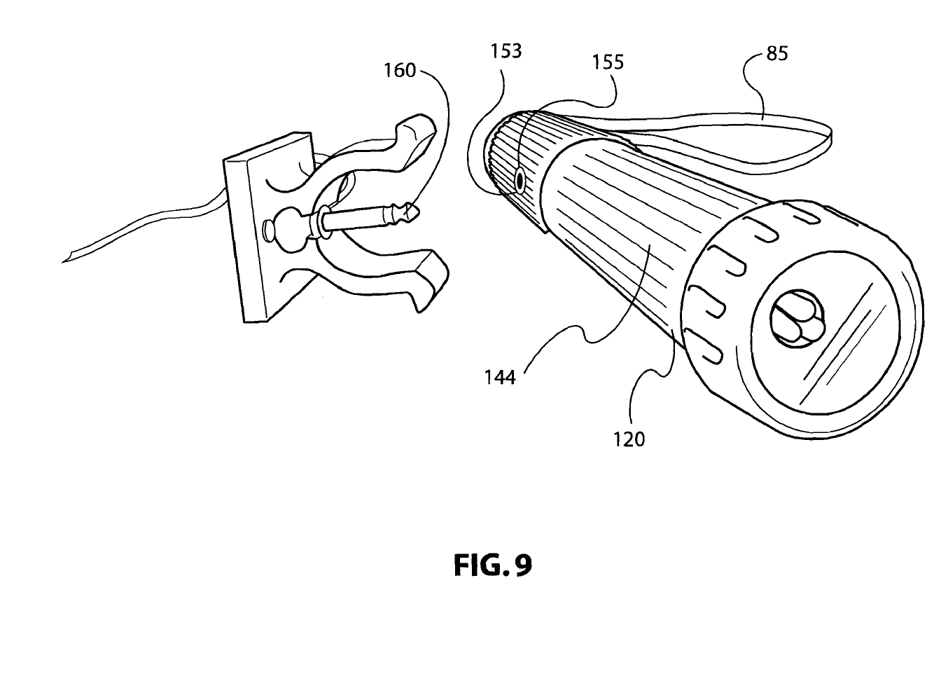

The deactivation post 60 discussed herein is a modified audio jack. This device was chosen because it was not able to be defeated by the consumer and because of the need to automatically activate the device upon its removal from the holder. Other devices could be used, such as magnetic reed switches or external contacts. The deactivation post 160 illustrated in FIG. 9 performs a dual purpose. Not only does the deactivation post 160 activate a switch 155 within a body 120 of a flashlight 115, the deactivation post 160 is an insulated dual contact audio jack that additionally delivers an electrical current to the body 120 to power a locator light 144 and, optionally, recharge the power supply (not shown). The deactivation post 160 fits within a receiving cavity 153 to deactivate the switch 155.

The station 25 provides a power supply for the locator light 44 and an actuation device for activating the alarm 50. The locator light 44 function could be accomplished by anything from a standard 120-volt, 125-watt incandescent light to an LED array. The actuation device for the alarm 50 is dependent upon the type of switch used to activate the alarm 50. The embodiment discussed herein uses the deactivation post 60 that breaks the circuit when it is inserted into a port. When the flashlight body 20 is removed from the station 25, the deactivation post 60 is removed and the circuit is completed. Other forms of actuation could include a magnetic reed switch (with the magnet in the holder), contacts which would provide a circuit to power a hold-open relay, or other devices accomplishing the same function. Another option would be to use a photocell to turn the light on and off.

The LED light has a very long life span as well as minimum current draw. As such, the light could remain on at all times.

As illustrated in FIG. 9, the flashlight body 120 may have a hand strap and/or a lanyard 85 to secure the flashlight body 120 to the hand of a user to prevent the flashlight body 120 from being dropped either accidentally or, if and when the user becomes incapacitated.

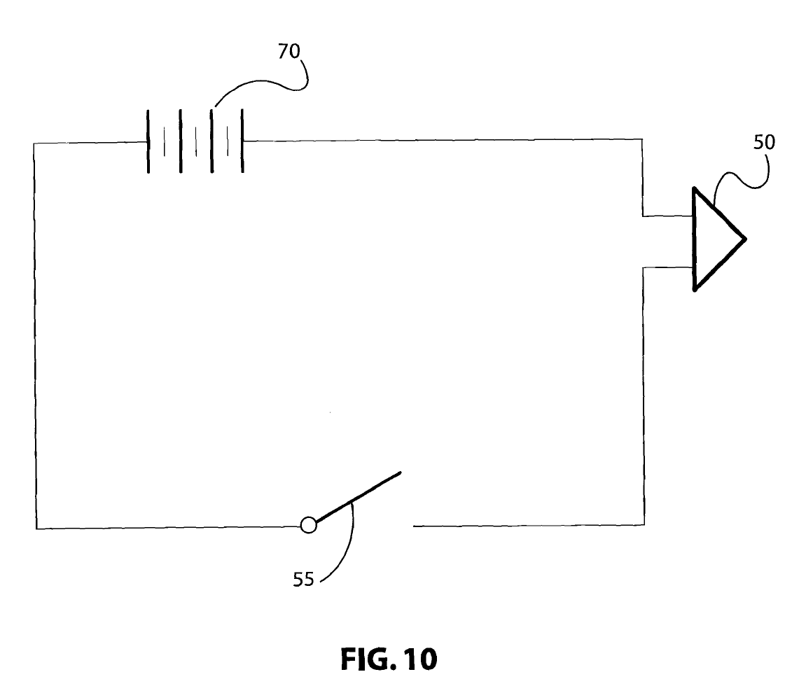

FIG. 10 illustrates a schematic of the electrical circuit of the audible alarm 55. A portable power supply 70, such as a 9-volt battery is connected to the audible alarm 50 and to the switch 50. As illustrated in FIG. 10, the switch 50 is open and this is caused by the insertion of the deactivation post 60 into the switch 55. When the deactivation post 60 is removed from the switch 55, the switch 55 closes, the circuit is energized, and the audible alarm 50 is activated. Although not shown, it is possible to add an illumination element 48 (FIG. 4) and a beacon 51 (FIG. 3) to the circuit.

While specific embodiments of the invention have been described in detail, it will be appreciated by those skilled in the art that various modifications and alternatives to those details could be developed in light of the overall teachings of the disclosure. The presently preferred embodiments described herein are meant to be illustrative only and not limiting as to the scope of the invention which is to be given the full breadth of the appended claims and any and all equivalents thereof.

The invention claimed is:

1. A portable alarm comprised of:
a) a flashlight having a body;
b) an audible alarm attached to the flashlight body;
c) a station for removably supporting the flashlight body, wherein the station is adapted to be secured to a surface and wherein the orientation of that surface may range from horizontal to vertical;
d) an electrical circuit comprised of a portable power source, an audible alarm and a switch to connect the power source and the audible alarm; and
e) wherein the switch is closed to activate the audible alarm by removing the flashlight body from the station.

2. The portable alarm in accordance with claim 1, further including a nightlight mounted on either the flashlight or the station.

3. The portable alarm according to claim 1, wherein the switch is a contact switch.

4. The portable alarm according to claim 3, wherein the switch is comprised of an activation post mounted to one of the flashlight body and the station and a receiving cavity mounted to the other of the flashlight body and the station, wherein the activation post disrupts a circuit in the flashlight body to deactivate the audible alarm.

5. The portable alarm according to claim 4, wherein the activation post/receiving cavity combination is comprised of an audio jack and associated receiving cavity.

6. The portable alarm according to claim 4, wherein the activation post/receiving cavity is part of a separate electrical circuit providing power to the nightlight associated with the station when the flashlight is mounted within the station.

7. The portable alarm according to claim 1, wherein the switch is a proximity switch.

8. The portable alarm according to claim 7, wherein the switch is a magnetic reed switch.

9. The portable alarm according to claim 1, wherein the station for removably supporting the flashlight is comprised of a base with two opposing resilient clips sized to resiliently clamp down on the flashlight body when inserted therebetween.

10. The portable alarm according to claim 1, wherein the audible alarm produces a sound different than a standard smoke alarm.

11. The portable alarm according to claim 1, wherein the portable power source is a battery.

12. The portable alarm according to claim 11, wherein the battery is a replaceable disposable battery.

13. The portable alarm according to claim 1, further including a visible alarm.

14. The portable alarm according to claim 13, wherein the visible alarm is comprised of at least one flashing light.

15. The portable alarm according to claim 1, wherein the body of the flashlight includes a wrist strap.

16. The portable alarm according to claim 1, wherein the flashlight may be activated when the flashlight body is removed from the station.

17. The portable alarm according to claim 1, wherein the flashlight is manually operated.

18. A method for revealing the location of an individual desiring to use the light from a flashlight, comprising the steps of:
a) providing a flashlight with a body having an audible alarm;
b) releasably securing the flashlight body in a holder;
c) providing a switch sensitive to the position of the flashlight body within the holder;
d) in a first position with the flashlight body secured within the holder, the switch is open and the audible alarm is disabled; and
e) in a second position with the flashlight body removed from the holder by the individual, the switch is closed and the audible alarm is enabled, thereby identifying the location of the individual by the audio signal emitted from the flashlight.

19. The method according to claim 18, wherein the audio alarm has a different sound than a smoke alarm.
